(19) United States
(12) Patent Application Publication
(10) Pub. No.: US 2022/0230254 A1
(43) Pub. Date: Jul. 21, 2022

(54) CROSS POLICY SINGLE CLAIM INSURANCE MANAGEMENT SYSTEM

(71) Applicant: LIFE & SPECIALTY VENTURES, LLC, Little Rock, AR (US)

(72) Inventor: Richard Hagen Macy, Little Rock, AR (US)

(73) Assignee: LIFE & SPECIALTY VENTURES, LLC, Little Rock, AR (US)

(21) Appl. No.: 17/578,107

(22) Filed: Jan. 18, 2022

Related U.S. Application Data
(60) Provisional application No. 63/137,891, filed on Jan. 15, 2021.

(51) Int. Cl. G06Q 40/08

(52) U.S. Cl. CPC G06Q 40/08

(57) ABSTRACT

An integrated supplemental protection technology system for generating an insurance payment or potential claim notification on a non-medical insurance contract using medical code information from a healthcare provider.

### CROSS-REFERENCE TO RELATED APPLICATIONS

This application claims the benefit of U.S. Provisional Application No. 63/137,891 filed Jan. 15, 2021, which is hereby incorporated by reference herein in its entirety.

### BACKGROUND OF THE INVENTION

### Field of the Invention

The present invention relates to improvements in insurance claim processing and payment. More particularly, the invention relates to improvements particularly suited for providing a scope of coverage payment for an insurance event covering multiple insurance areas. In particular, the present invention relates specifically to a cross policy single claim insurance management system.

### Background

As will be appreciated by those skilled in the art, insurance policies or contracts are known in various forms. Patents disclosing information relevant to insurance include U.S. Pat. No. 7,246,070, issued to Schwartz, et al. on Jul. 17, 2007, titled Method and apparatus or bundling insurance coverages in order to gain a pricing advantage; U.S. Pat. No. 7,451,097 issued to Faupel, et al. on Nov. 11, 2008, titled Method, data storage medium, and computer system for generating a modular multi-coverage insurance product; U.S. Pat. No. 7,685,007 issued to Jacobson on Mar. 23, 2010, titled Method for linking insurance policies; U.S. Pat. No. 7,774,217 issued to Yager, et al. on Aug. 10, 2010, titled Systems and methods for customizing automobile insurance; U.S. Pat. No. 7,885,830 issued to Johnson, et al. on Feb. 8, 2011, titled Infrastructure method and system for managing deductibles for insurance policies; U.S. Pat. No. 7,890,359 issued to Jacobson on Feb. 15, 2011, titled Method for linking insurance policies; U.S. Pat. No. 8,046,244 issued to Yager, et al. on Oct. 25, 2011, titled Systems and methods for customizing insurance U.S. Pat. No. 8,069,067 issued to Schmidlin, et al. on Nov. 29, 2011, titled Computer-based system and method for estimating costs of a line of business included in a multi-line treaty; U.S. Pat. No. 8,082,163 issued to Harkensee, et al. on Dec. 20, 201, titled Methods for selling insurance using rapid decision term; U.S. Pat. No. 8,185,416 issued to Jacobson on May 22, 2012, titled Method for linking insurance policies; U.S. Pat. No. 8,219,421 issued to Schwartz, et al. on Jul. 10, 2012, titled Method and apparatus for bundling insurance coverages in order to gain a pricing advantage; U.S. Pat. No. 7,885,835 issued to Amigo, et al. on Oct. 1, 2009, titled System and method for increasing capacity in an insurance system; U.S. patent application Ser. No. 12/204,601 filed by Fennelly, Michael J. on Sep. 4, 2008, titled Systems and methods for providing distributions to association members based on affinity programming; U.S. patent application Ser. No. 12/623,572 filed by Heydon, et al. on Nov. 23, 2009, titled insurance Policy Revisioning Method; U.S. Pat. No. 7,890,359 issued to Jacobson, Neil L. on Sep. 2, 2010, titled Method for linking insurance policies; U.S. Pat. No. 8,433,588 issued to Willis, et al. on Sep. 2, 2010, titled Customizable Insurance System; U.S. Pat. No. 8,666,784 issued to Stepeck, et al. on Apr. 21, 2011, titled Systems and methods for administering comprehensive protection plans; U.S. Pat. No. 10,055,792 issued to Price, Michael on May 5, 2011, titled System and method for automated risk management appraisal; U.S. Pat. No. 8,315,888 issued to Folsom, David on Aug. 18, 2011, titled Method and system for estimating unpaid claims; U.S. Pat. No. 10,692,152 issued to Stepeck, et al. on Jun. 23, 2020, titled Systems and methods for cross-system parameter coordination.

Insurance is a means of protection from financial loss as a form of risk management. An insurer, insurance company, insurance carrier or underwriter provides the insurance contract to the insured also known as a policyholder. The insurance policy puts forth the terms, including the premium and covered losses, for the insurer to financially reimburse the insured for a covered loss. The insured submits a claim to the insurer for processing by a claims adjuster. The insurer may spread the risk of the insurance policy by taking out reinsurance with another insurance company.

Insurance companies may limit themselves to areas such as life insurance, which include life insurance policies, annuities and pension products; asset management businesses; non-life or property/casualty insurance; or health insurance. Thus, companies may be general insurance companies or may specialize in the various insurance area types including auto insurance, Gap insurance, health insurance, income protection insurance, casualty insurance, life insurance, burial insurance, property insurance, liability insurance, credit insurance, mortgage insurance, trade credit insurance, collateral protection insurance (CPI), all-risk insurance, bloodstock insurance, business interruption insurance, Defense Base Act (DBA) insurance, expatriate insurance, Hired-in Plant insurance, legal expenses insurance, livestock insurance, media liability insurance, nuclear incident insurance, pet insurance, pollution insurance, purchase insurance, tax insurance, title insurance, travel insurance, tuition insurance, divorce insurance, insurance financing vehicles, and closed community and governmental self-insurance. As shown in FIG. 1, an insured 10, such as a person or a family, typically has some form of health insurance agreement 11 that provides insurance coverage 22 that is generally provided by an employer or carrier 20 to cover healthcare treatment 12 by a healthcare provider or hospital 50. Note that the healthcare treatment 12 may be simple wellness trips or could be accidents or health issues. After the healthcare treatment 12, the healthcare provider 50 notifies the carrier 20 and transfers the codes of the treatments shown as medical insurance claim information 102. The medical codes are used to describe diagnoses and treatments, determine costs, and reimbursements, and relate one disease or drug to another. The codes can include Current Procedural Terminology (CPT) codes to describe every type of service (tests, surgeries, evaluations, and any other medical procedures) that a healthcare provider provides to a patient. These codes can also include Healthcare Common Procedure Coding System (HCPCS) codes, Level I HCPCS codes, Level II HCPCS codes, International Classification of Diseases (ICD) codes, International Classification of Functioning, Disability, and Health, commonly known as ICF codes, diagnostic-related group (DRG) codes, National Drug Code (NDC) codes, Code on Dental Procedures and Nomenclature (CDT) codes, and Diagnostic and Statistical Manual of Mental Disorders, 4th Edition, Text Revision (DSM-IV-TR) codes as examples of a few of the types of codes that can be utilized. Once the medical insurance claim information 102 is received, the medical insurer 30 sends health provider payment 32 for the healthcare to the healthcare provider 50. In this example, the carrier 20 has subcontracted 23 with a medical insurer 30 for the health provider payment 32.

FIG. 2 shows how if the insured 10 wanted additional protection such as a car insurance policy, personal accident insurance, home insurance policy or non-medical insurance contract 14, the insured 10 contracts 14 directly with second non-medical insurer 40, and files a separate non-medical policy claim 104 for an event in order to receive the non-medical insurance policy payment 106.

### SUMMARY OF THE INVENTION

The present invention is directed to an improved integrated health insurance technology that uses medical code information to automate supplemental protection claim submission and adjudication. In accordance with one exemplary embodiment of the present invention, an insurance company uses healthcare provider medical procedure code information to initiate direct to insured payments for nonmedical insurance such as accident insurance.

This invention provides the advantage of removing a requirement for the insured to file a separate insurance claim when medical care is undertaken for an underlying event.

Another advantage is allowing insurance carriers to utilize medical codes as a basis for payments on non-medical insurance policies.

A still further advantage is reducing costs associated with claim adjusters within insurance companies by facilitating insurance payments based on medical codes.

A still further advantage is notifying insurance holders of potential claim filings using medical codes as an indicator of potential claims.

These and other objects and advantages of the present invention, along with features of novelty appurtenant thereto, will appear or become apparent by reviewing the following detailed description of the invention.

### BRIEF DESCRIPTION OF THE SEVERAL VIEWS OF THE: DRAWINGS

In the following drawings, which form a part of the specification and which are to be construed in conjunction therewith, and in which like reference numerals have been employed throughout wherever possible to indicate like parts in the various views:

FIG. 1 is a schematic view of a medical insurance transaction.

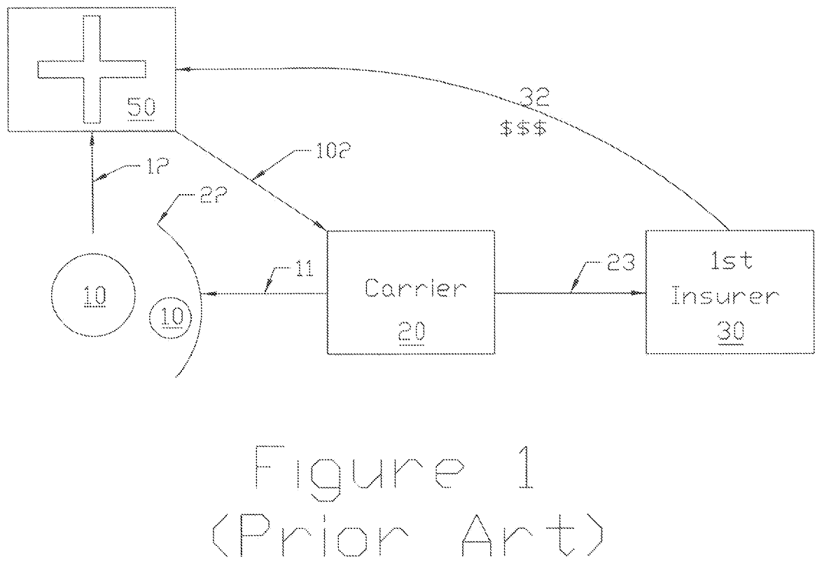

FIG. 2 is a schematic view of a non-medical insurance transaction.

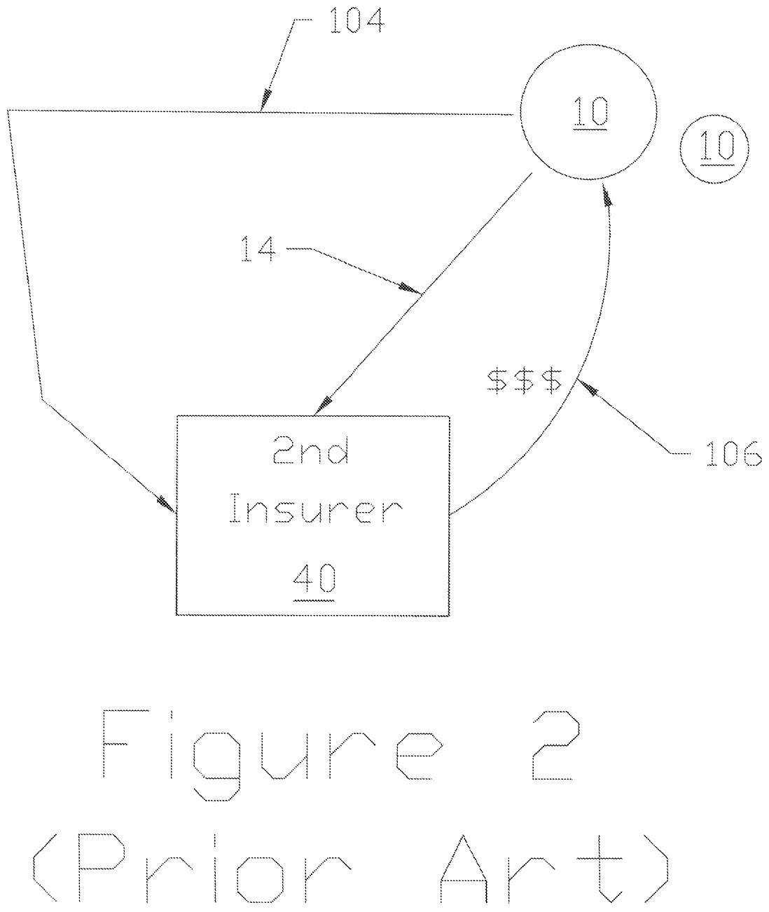

FIG. 3 is a schematic view of a non-medical insurance payment based on a medical insurance transaction.

FIG. 4 is a flow chart of a non-medical payment process using medical codes.

### DETAILED DESCRIPTION OF THE INVENTION

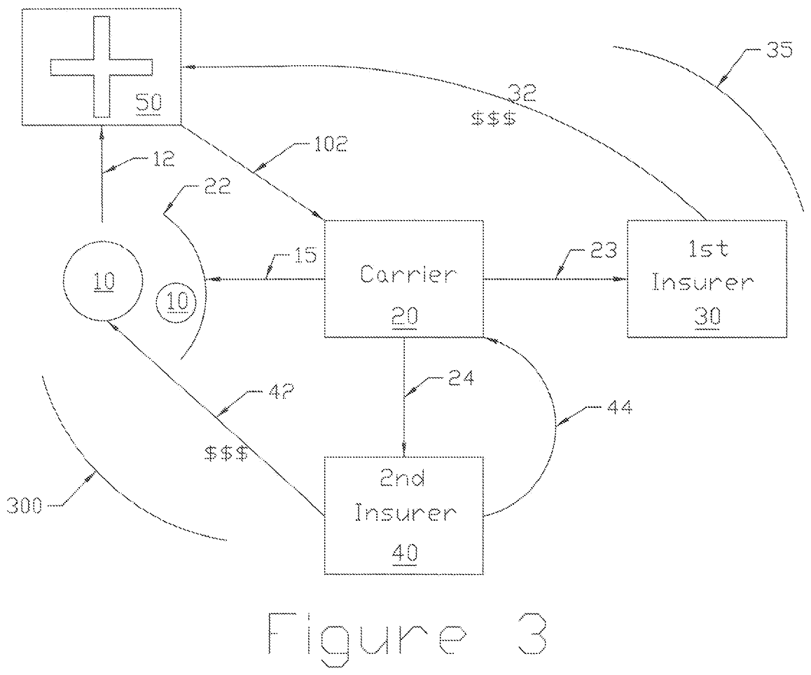

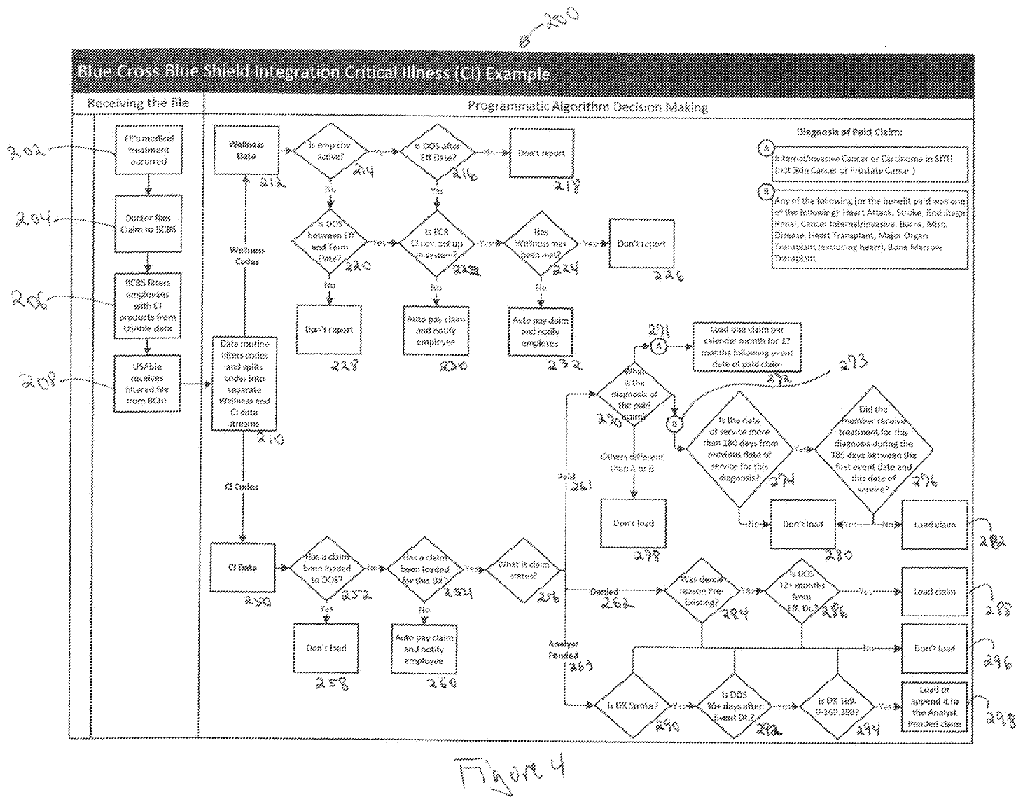

As shown in FIGS. 3 and 4 of the drawings, one exemplary embodiment of the present invention is generally shown as an integrated supplemental insurance protection technology system 100 for working with an insured 10. The insured 10 may use a carrier 20 such as an employer or the like that provides an insurance coverage 22. For the embodiment provided herein, the system 100 uses medical insurance claims 102 to facilitate both health provider claim adjudication 35 and supplemental insurance protection claim adjudication 300.

To understand the process of the system 100, we can consider an example. The insured 10 is a family consisting of John and his son Derrick. John has healthcare and non-healthcare supplemental insurance agreements 15 with an insurance carrier 20 (his employer) that has a first medical insurance policy 23 (for medical coverage) through a first medical insurer 30 (primary health insurance provider) as well as a second supplemental non-medical insurance policy 24 (for accident insurance) through a second non-medical supplemental insurer 40 (supplemental insurance provider) for his son Derrick. In this example, Derrick has an accident at school, breaks his collarbone, and is medically treated 12 at the local healthcare provider 50 such as an emergency room. When the local healthcare provider 50 submits the medical insurance claim information 102 to the carrier 20, the health insurance carrier 20 will send the medical insurance claim information 102 to the first medical insurer 30 for medical payment 32 of the medical bills. The health insurance carrier 20 will also submit the medical insurance claim information 102 to the second non-medical insurer 40. Since Derrick is covered under the second non-medical insurance policy 24 for reimbursement in case of an accident that results in a collarbone fracture, the second non-medical insurer 40 will automatically send the insured 10 (John) a medical code initiated claim payment 42 for the appropriate benefit amount. In this manner, the medical insurance claim information 102 from the local healthcare provider 50 results in an medical code initiated payment 42 to the insured 10 without requiring the insured to file a separate report/claim.

In this embodiment, the supplemental insurance provider 40 provides supplemental protection products 24 which can integrate with medical insurance claims 102. Supplemental protection insurance products include accident, critical illness, hospital indemnity, and cancer insurance and may also have integration for GAP insurance as well. This technology is in place for employer groups with policy/certificates and may be implemented for direct to consumer individual policies.

The integrated supplemental protection technology system 100 uses the following supplemental process 200:

(a) The supplemental protection insurance provider 40 will notify the health insurance carrier 20 which insured participants 10 have enrolled and met requirements for supplemental protection insurance provider accident, critical illness, hospital indemnity or cancer insurance via electronic data interchange 44.

(b) The health insurance carrier 20 will use the supplemental protection insurance provider 40 enrollment information to identify medical claims 102.

(c) The supplemental protection insurance provider 40 will securely (HIPAA compliant), receive medical insurance claims 102 from health insurance carriers 20 via electronic data interchange 24 for the insured members 10 identified.

(d) The supplemental protection insurance provider 40 will maintain connections to the health insurance carrier 20 for groups with supplemental products in a secured location at the supplemental protection insurance provider data enter.

(e) The supplemental protection insurance provider 40 will execute an algorithm, shown in FIG. 4 with programmatic decision gates 202-298 to determine which supplemental benefits are payable as a medical code initiated payment 42 based upon diagnosis, procedure, and other related medical claim codes received from the health insurance carrier 20.

(f) If the medical claimant insured 10 has supplemental protection insurance provider 40 coverage and the medical claim code is eligible for a supplemental protection insurance provider benefit one of the following will occur:

1. The supplemental protection insurance provider 40 will generate payment for the accident, critical illness, hospital indemnity or cancer claim without intervention.

2. If additional information or human intervention is needed, a supplemental. protection insurance provider 40 claim examiner will be notified of the eligible claim and begin adjudication as well as communication with the potential claimant 10.

3. The supplemental protection insurance provider will generate communication to the insured 10 notifying them they may be eligible for a claim or a claim has been paid.

The veracity process 200 for confirming the facts aid accuracy of the contract effectiveness is detailed in FIG. 4 as follows:

The insured medical treatment occurs 202. The healthcare provider submits 204 the medical insurance claim information. The system filters 206 for supplemental insurance with the supplemental insurer and transmits 208 the supplemental claims to the supplemental insurer. The medical insurance claim information 102 includes the codes for the medical procedures performed. A system analyzes the codes using a decision process to determine 210 if the codes indicate a wellness visit or a medical procedure claim code and directs the process accordingly.

For codes indicating a wellness visit 212, the system checks to see if the wellness coverage is still active 214. If the wellness coverage is still active, the system checks the effective date 216. If the coverage is not still active, the system checks the span of the term of coverage 220.

Checking the effective date 216 checks to ensure the medical treatment occurred after the effective date of the insurance 216. If the treatment was before the effective date, then the system does not report the information 218. If the treatment was after the effective date, then the system checks if the extra contractual restriction claim coverage is set up for the received codes 222.

Checking the span of the term of coverage 220 checks if the medical treatment occurred during the coverage term. If the treatment occurred during the coverage term then the system checks if the extra contractual restriction claim coverage is set up for the received codes 222. If the treatment did not occur during the coverage term then the system does not report the information 228.

Checking if the extra contractual restriction claim coverage is set up for the received codes 222 checks to see if the insurance policy coverage is restricted. If the claim coverage is restricted then the system checks to see if the maximum payment has already been paid 224. If the claim coverage is not restricted, then the claim is paid by generating the payment such as printing a check and mailing it, electronically depositing or wiring the money such as into an account for the insured, or other payment method and the insured is notified 230 by their preferred method such as mail, email, teat message, telephone call, telegram, facsimile or other communication method.

Checking if the maximum payment has already been paid 224 reviews total payment and contractual limits. If the contractual limits have been reached, then the system does not report the information 226. If the contractual limits have not been reached, then the claim is paid by generating the payment and the insured is notified 232.

For codes indicating a health claim visit 250, the system checks to see if the claim has been already been loaded 252. If the claim has previously been loaded 252, then the system bypasses the claim and does not load this claim. If the claim has not been loaded, then the system checks the claim diagnosis status 256.

Checking the claim diagnosis status 256 checks whether the claim is paid 261 denied, 262, or pending analyst review 263. If the claim diagnosis status is paid 261, then the system checks the paid claim diagnosis 270. If the claim is denied 262, then the system checks for preexisting issues 284. If the claim is pending analyst review 263, then the system checks for a stroke diagnosis 270.

Checking the-diagnosis of the paid claim 270 looks to whether the claims is in situ cancer or carcinoma 271, a major event claim 273, or a lesser event 270.

If the claim is in situ cancer or carcinoma 271, the system loads one claim for each calendar month for a twelve-month period following the event date of the first paid claim.

If the claim is a major event claim 273, such as a heart attack, stroke, end stage renal, cancer internal/invasive, burns, miscellaneous disease, heat transplant, other major organ transplant, or bone marrow transplant, then the system checks for to see if the claim is within 180 days of a previous date of service for the diagnosis 274. If the claim is within 180 days then the system checks for treatment within the 180 day period. If the claim is not within 180 days, then the system does not load the information 280.

Checking if the treatment within the 180 day period since the event date 276 determines if this is a new treatment set. If the treatment is within the 180 days from the event date 276, then the system does not load the information 278. If the treatment is not within the 180 days from the event date 276, then the system loads the claim 282.

It the claim is a lesser event 270 than the previous events 271, 273, then the system does not load the information 278.

Checking the diagnosis of the denied claim 262 checks if the denial reason is preexisting 284. If the denial reason is preexisting 284, then the system checks the time from the effective date 286. If the denial reason is not preexisting 284, then the system does not load the information 296.

Checking the time from the effective date 286 looks to see if the date of service is more than 12 months after the effective date of the insurance. If the effective date is more than 12 months after the effective date 286, then the claim is loaded 288. If the effective date less than 12 months, then the system does not load the information 296.

Checking if the claim is pending, an analyst looks to whether the claims is as stroke 290. If the claim is not a stroke, then the system does not load the information 296. If the claim is a stroke 290, then check if the date of service is more than 30 days after the event date 292.

Checking if the date of service is more than 30 days after the event date 292 checks for related events. If the date of service is not more-than 30 days after the event date 292, then the system does not load the information 296. If the date of service is more than 30 days after the event date 292, then the system checks for a critical illness 294 for diagnosis codes 169.0 to 169,398.

Checking for a critical illness 294 is checking for codes that illustrative of as medical diagnosis that would trigger a claim under our supplemental critical illness plan. If a critical illness code is found, then the system loads or appends the analyst pending claims 298. If no critical illness code is found, then the system does not load the information 296.

As used herein, “checks” and “checking” mean the system searches or interrogates a database for data or transmits a request for data to a remote server, receives the data and analyzes the data to determine whether a condition exists. Analysis of the data may include comparing the data to other data or parameters to determine whether the condition exists. As used herein, “load” means to modify or transform existing data or information, for example, by changing, inserting into or appending to existing data or information, to create new data or information.

Reference numerals used throughout the detailed description and the drawings correspond to the following elements:
insured 10
health insurance agreement 11
healthcare treatment 12
non-medical insurance contract 14
employer or carrier 20
insurance coverage 22
subcontracted 23
medical insurer 30
health provider payment 32
non-medical insurer 40
healthcare provider or hospital 50
integrated supplemental protection technology system 100
medical insurance claim information 102
non-medical policy claim 104
non-medical insurance policy payment 106
integrated supplemental protection technology system 100
medical insurance claims 102
supplemental protection claim adjudication 300
health insurance carrier 500
first insurance policy 510
primary health insurance provider 512
second insurance policy 520
supplemental protection insurance provider 522
claim payment 600

From the foregoing, it will be seen that this invention is well adapted to obtain all the ends and objectives herein set forth, together with other advantages which are inherent to the structure. It will also be understood that certain features and subcombinations are of utility and may be employed without reference to other features and subcombinations. This is contemplated by and is within the scope of the claims. Many possible embodiments may be made of the invention without departing from the scope thereof. Therefore, it is to be understood that all matter herein set forth or shown in the accompanying drawings is to be interpreted as illustrative and not in a limiting sense.

When interpreting the claims of this application, method claims may be recognized by the explicit use of the word ‘method’ in the preamble of the claims and the use of the ‘ing’ tense of the active word. Method claims should not be interpreted to have particular steps in a particular order unless the Claim element specifically refers to a previous element, a previous action, or the result of a previous action. Apparatus claims may be recognized by the use of the word ‘apparatus’ in the preamble of the claim and should not be interpreted to have ‘means plus function language’ unless the word ‘means’ is specifically used in the claim element. The words ‘defining,’ ‘having,’ or ‘including’ should be interpreted as open ended claim language that allows additional elements or structures. Finally, where the claims recite “a” or “a first” element of the equivalent thereof, such claims should be understood to include incorporation of one or more such elements, neither requiring nor excluding two or more such elements.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions or executable portions embodied therein.

It will also be understood that one or more computer-executable program code portions or instruction code for carrying out or performing the specialized operations of the present invention may be required on the specialized computer include object-oriented, scripted, and/or unscripted programming languages, such as, for example, Java, Perl, Smalltalk, C++, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An insurance payment method for an accident, hospital indemnity, critical illness or cancer insurance payment to an insured based on an accident, hospital indemnity, critical illness or cancer insurance contract with an insurance company, where the insured had medical treatment resulting in the reporting of medical code information, the insurance payment method comprising:
transmitting the medical code information to the accident insurance company; and
verifying the veracity of the insurance contract; and
generating the accident, hospital indemnity, critical illness or cancer insurance payment for the insured.

2. The insurance payment method of claim 1, wherein transmitting further comprises:
providing a health insurance carrier;
receiving the medical code information by the health insurance carrier; and
forwarding the medical code information to the supplemental product insurance company.

3. The insurance payment method of claim 2, wherein transmitting further comprises:
screening medical code information at the health insurance carrier to identify selective medical code information to forward to the accident, hospital indemnity, critical illness or cancer insurance company.

4. The insurance payment method of claim 2, wherein transmitting further comprises:
the accident, hospital indemnity, critical illness or cancer insurance company notifying the health insurance carrier of enrolled accident, hospital indemnity, critical illness or cancer insurance participants that have enrolled and met requirements of the accident, hospital indemnity, critical illness or cancer insurance contact.

5. The insurance payment method of claim 2, wherein transmitting further comprises:
screening medical code information at the health insurance carrier to identify enrolled accident, hospital indemnity, critical illness or cancer insurance participants,

6. The insurance payment method of claim 1, wherein generating the accident, hospital indemnity, critical illness or cancer insurance payment for the insured further comprises:
determining the veracity of the accident, hospital indemnity, critical illness or cancer insurance payment based upon the medical code information.

7. The insurance payment method of claim 1, wherein generating the accident, hospital indemnity, critical illness or cancer insurance payment for the insured further comprises:
providing a claim examiner to review the medical code information; and
notifying the claim examiner using the medical code information.

8. The insurance payment method of claim 1, wherein generating the accident, hospital indemnity, critical illness or cancer insurance insurance payment for the insured further comprises:
notifying the insured of the accident, hospital indemnity, critical illness or cancer insurance insurance payment using the medical code information.

9. The insurance payment method of claim 1, wherein generating the accident, hospital indemnity, critical illness or cancer insurance insurance payment for the insured further comprises:
notifying the insured of a potential claim using the medical code information.

10. A health insurance technology method for use with medical code information associated with an insured and a non-medical insurance contract having contact terms, comprising:
receiving the medical code information;
verifying the veracity of the medial code information and the contract terms; and
generating a non-medical insurance payment for the insured.

11. The insurance payment method of claim 10, wherein transmitting further comprises:
providing a health insurance carrier;
receiving the medical code information by the health insurance carrier; and
forwarding the medical code information to the non-medical insurance company.

12. The insurance payment method of claim 11, wherein transmitting further comprises:
screening medical code information at the health insurance carrier to identify selective medical code information to forward to the non-medical insurance company.

13. The insurance payment method of claim 11, wherein transmitting further comprises:
the non-medical insurance company notifying the health insurance carrier of enrolled non-medical insurance participants that have enrolled and met requirements of the non-medical insurance contact.

14. The insurance payment method of claim 11, wherein transmitting further comprises:
screening medical code information at the health insurance carrier to identify enrolled non-medical insurance participants.

15. The insurance payment method of claim 10, wherein generating the non-medical insurance payment for the insured further comprises:
determining the veracity of the non-medical insurance payment based upon the medical code information.

16. The insurance payment method of claim 10, wherein generating the non-medical insurance payment for the insured further comprises:
providing a claim examiner to review the medical code information; and
notifying the claim examiner using the medical code information.

17. The insurance payment method of claim 10, wherein generating the non-medical insurance payment for the insured further comprises:
notifying the insured of the non-medical insurance payment using the medical code information.

18. The insurance payment method of claim 10, wherein generating the non-medical insurance payment for the insured further comprises:
notifying the insured of a potential claim using the medical code information.
